(19) United States
(12) Patent Application Publication
(10) Pub. No.: US 2016/0063052 A1
(43) Pub. Date: Mar. 3, 2016

(54) METHOD AND SYSTEM FOR VALIDATING INFORMATION

(71) Applicant: Accenture Global Services Limited, Dublin (IE)

(72) Inventor: Subrahamanian Natarajan, Edison, NJ (US)

(21) Appl. No.: 14/473,359

(22) Filed: Aug. 29, 2014

(51) Int. Cl. G06F 17/30

(52) U.S. Cl. CPC G06F 17/30371; G06F 17/3053

(57) ABSTRACT

A method for maintaining the validity of data includes receiving, by a master data management (MDM) system and from a requesting system, a request to view information stored in master data of the MDM system. The MDM system communicates the information to the requesting system. Data that defines a score that represents a validity of the information is received from the requesting system. The MDM system updates a validity score associated with the information. When the validity score indicates to the MDM system that the information is invalid, the MDM system corrects the information.

### BACKGROUND

1. Field

This application relates to systems that store information. In particular, this application is related to a method for validating information stored by a master data management system.

2. Description of Related Art

Master Data Management (MDM) systems are typically utilized to aggregate data from multiple sources, organize the data, and then to generate master data that may be considered as containing authoritative data for consumption by other systems and users of those systems. Such systems typically allow users to access a subset of information stored in the master data via a portal or view. For example, the portal may provide a view with information associated with a single consumer, employee, product, etc.

Users of these systems are often under the impression that the data provided by MDM system is accurate. However, the data stored in the master data is only as accurate as the source of the data. For example, human resources personnel may, via a human resources (HR) system, enter HR-related information associated with a new employee. Operator error may result in inaccurate information being stored in the HR system. This inaccurate information is eventually propagated into the master data and then to other systems that rely on the master data.

### BRIEF SUMMARY

Methods, systems, and computer-readable media are provided that facilitate maintaining the validity of data in a master data management system.

In one aspect, a method for maintaining the validity of data includes receiving, by a master data management (MDM) system and from a requesting system, a request to view information stored in master data of the MDM system. The MDM system communicates the information to the requesting system. Data that defines a score that represents a validity of the information is received from the requesting system. The MDM system updates a validity score associated with the information based on the data received from the requesting system. When the validity score indicates to the MDM system that the information is invalid, the MDM system corrects the information in the master data.

In a second aspect, a master data management (MDM) system for maintaining the validity of data includes a network interface configured to receive and process a request from a requesting system to view information stored in master data of the MDM system. The network interface is further configured to communicate the information to the requesting system and to receive data from the requesting system that defines a score that represents the validity of the information. A processor of the system is configured to update a validity score associated with the information. When the validity score indicates to the processor that that the information is invalid, the processor is further configured to correct the information in the master data.

In a third aspect, a non-transitory machine-readable storage medium stores a computer program that includes at least one code section for maintaining the validity of data. The code section is executable by a machine for causing the machine to receive a request to view information stored in master data of the MDM system from a requesting system and to communicate the information to the requesting system. The machine also receives, from the requesting system, data that defines a score that represents the validity of the information and updates a validity score associated with the information. When the validity score indicates to the MDM system that the information is invalid, the code section is configured so as to cause the machine to correct the information.

### BRIEF DESCRIPTION OF THE DRAWINGS

FIG. 1 illustrates an exemplary environment that includes a master data management (MDM) system and a group of remote systems in communication with the MDM system;

FIGS. 2A-2C illustrate exemplary views of master data that may be presented by a remote system to a user;

FIG. 3 illustrates exemplary master data of the MDM system;

FIG. 4 illustrates exemplary validation data utilized by the MDM system to validate information in the master data;

FIGS. 5A-5C illustrate manifest information that governs the flow of information between the MDM system and the remote systems;

FIG. 6 illustrates a group of exemplary operations that may be performed by the MDM system; and

FIG. 7 illustrates a computer system that may correspond to any processing systems described below.

### DETAILED DESCRIPTION

The embodiments described below overcome the problems with known MDM systems by providing a MDM system that communicates information associated with various fields stored in master data to remote systems, and that receives indications of validity of the information from the remote systems along with possible alternative values for the fields. The MDM system replaces the information associated with a given field after determining the alternative value is more valid than the currently stored information. In this way, the MDM system has at least the technical effect of lowering or eliminating the storage requirements of the various remote systems by providing a common source of validated data for consumption by the remote systems, thus relieving the remote systems of the burden of having to maintain the information locally.

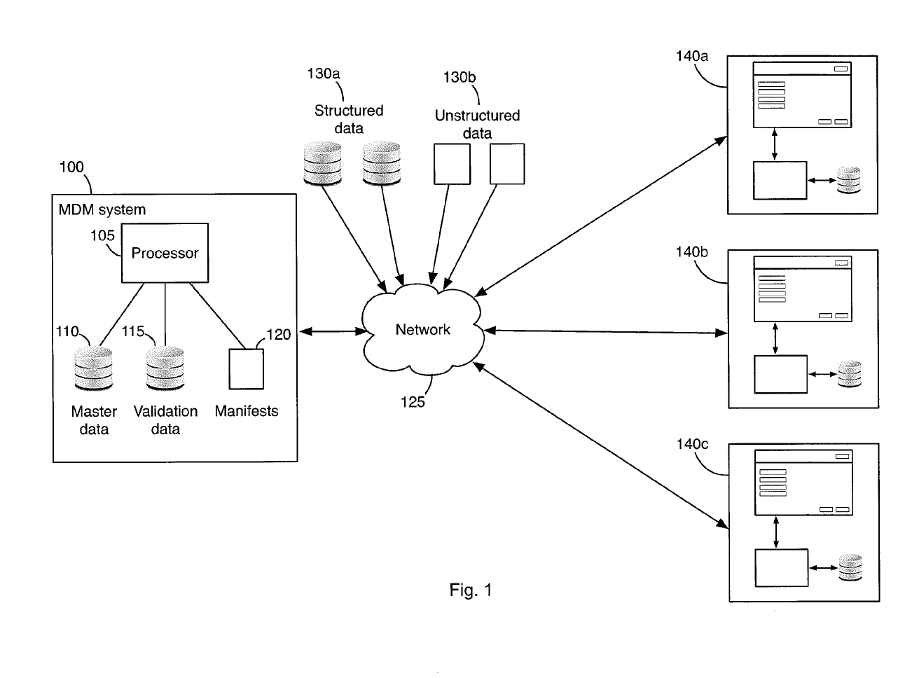

FIG. 1 illustrates an exemplary environment that includes a master data management (MDM) system 100 and a group of remote systems 140a-c in communication with the MDM system 100. In general, the MDM system 100 is configured to aggregate data from one or more structured data sources 130a, unstructured data sources 130b, and remote systems 140a-c into a database or other form of data store that stores master data 110. Data from these data sources may be communicated to the MDM system via a network 125, such as the Internet or a different network.

In an enterprise environment, the remote systems 140a-b may correspond to systems within the enterprise such as human resources systems 140a, payroll systems 140b, etc. Remote systems 140c, such as social networking systems 140c, may reside inside or outside the enterprise environment. For example, the remote system 140c may correspond to a LinkedIn® server, Facebook® server, etc.

The MDM system 100 includes a processor 105 that communicates information to and from one or more storage devices that store master data 110, validation data 115, and manifests 120. The processor 105 may correspond to a computer system with server capabilities that includes one or more network interfaces that facilitate communications via the network 125. While the processor 105 is illustrated as a single entity, it is understood that the processor 105 may comprise various modules or subsystems that are interconnected with one another via various forms of communication links. The processor 105 and/or the modules and subsystems may correspond to Intel®, AMD®, or PowerPC® based computers or different computers. The computers may execute operating systems, such as Microsoft Windows®, Linux, Unix® or other operating systems.

Storage devices for storing the master data 110, validation data 115, and manifests 120 may correspond to hard drives, solid state storage devices, etc. While the various data items are illustrated as being directly accessible to the processor 105, it should be understood that the data items might be accessed via different systems in communication with the processor 105, such as one or more remote servers that maintain the data items.

Each remote system 140a-c may correspond to or be considered as a computer system in communication with a local storage device for storing information associated with the remote system 140a-c. The remote systems 140a-c may be configured to request access to the master data 110 via the network 125. For example, the MDM system 100 may provide a lightweight directory access protocol (LDAP) style API, open database connectivity (ODBC) style API, search API and/or a different API to facilitate access to the master data 110. Information associated with requested fields of the master data 110 and/or other information associated with the requested fields may be communicated to the remote systems 140a-c in a consistent format such as a graph format.

Access may be requested to facilitate moving locally stored information to the master data 110, reconciling locally stored information with the master data 110, supplementing locally stored data with information in the master data 110, and/or providing information for validating information stored in the master data 110. In this regard, each remote system 140a-c may be restricted to accessing a subset of the master data 110. For example, bank routing numbers may be communicated from a payroll system to the master data 110, but not shared with other remote systems.

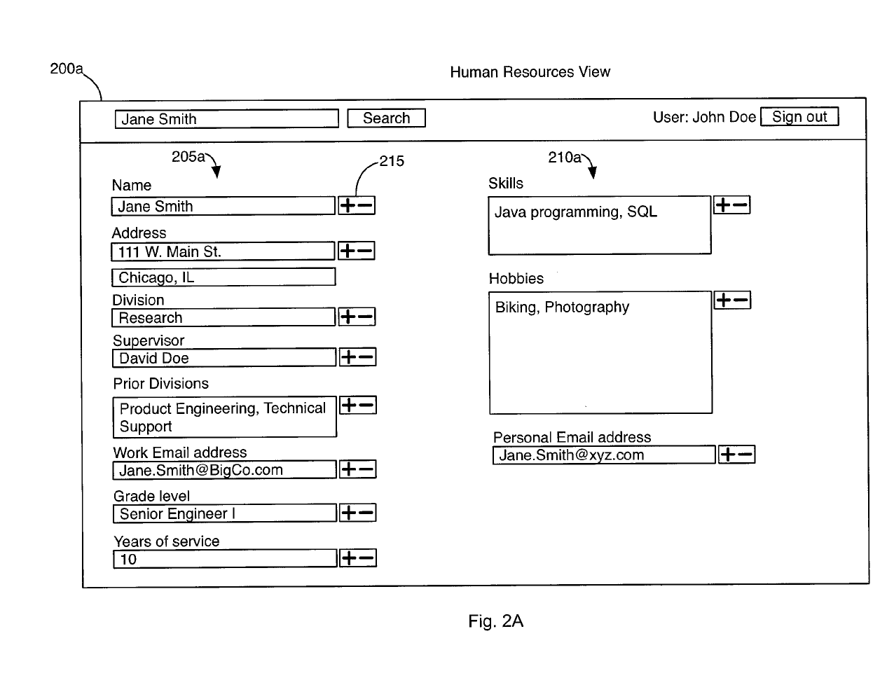

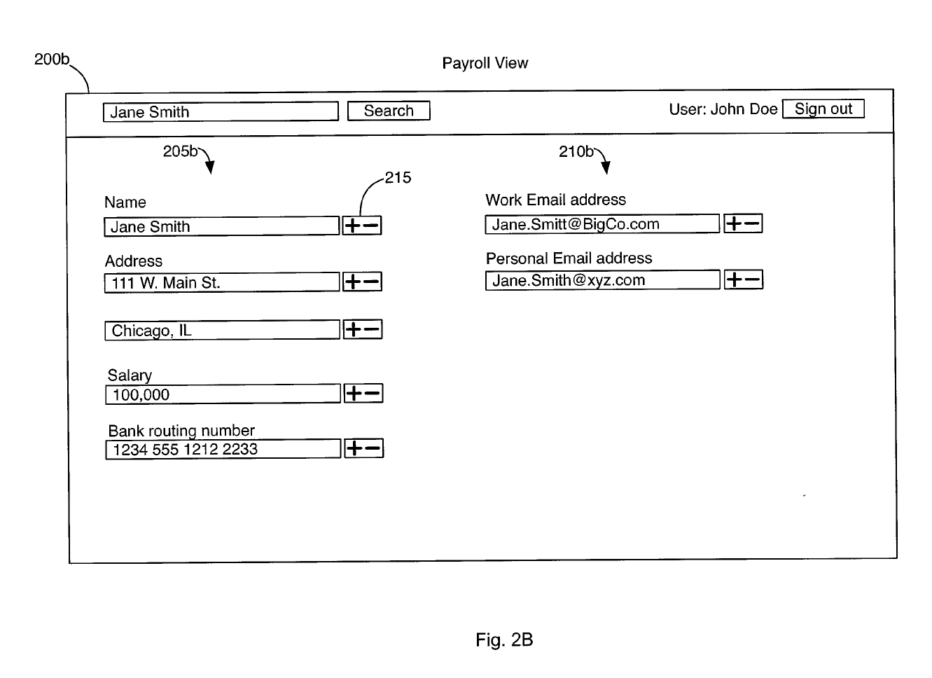

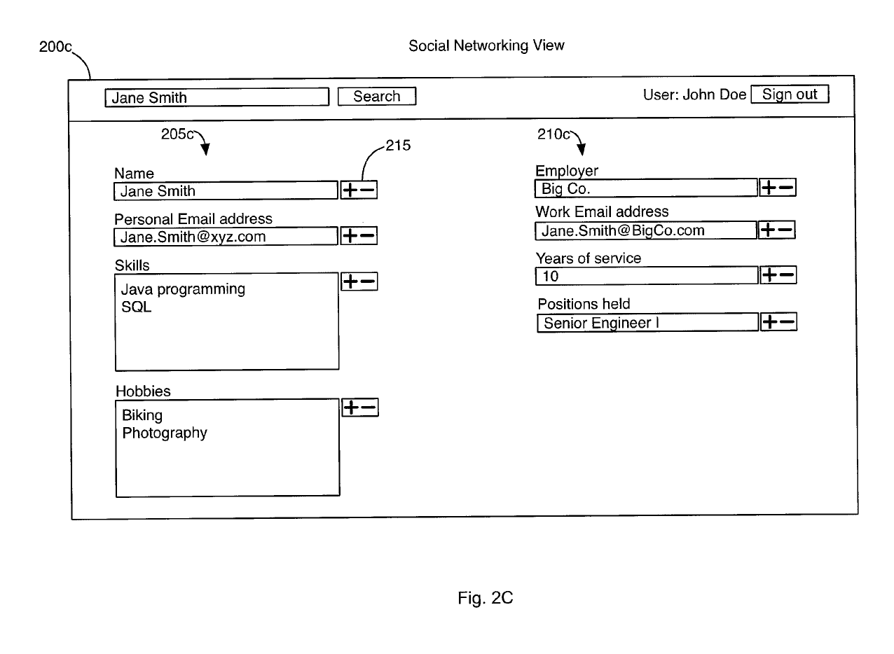

Each remote system 140a-c may be further configured to present locally stored and/or sourced information to a user, and to receive input regarding the information from the user. For example, referring to FIG. 2A, a human resources system 140a may present a view 200a to a user to facilitate viewing and editing locally stored and/or sourced human resources-related information 205a, such as an individual's name, address, corporate division, etc. Referring to FIG. 2B, a payroll system 140b may present a view 200b to a user to facilitate viewing and editing locally stored and/or sourced payroll-related information 205b, such as a routing number for depositing a paycheck. Referring to FIG. 2C, a social networking system 140c may present a view 200c to a user that facilitates viewing and editing locally stored and/or sourced information 205c such as skills and hobbies associated with the individual. The respective views 200a-c may also be configured to facilitate viewing and editing information 210a-c that is stored by the MDM system 100, which may have been sourced by another remote system 140a-c.

In some implementations, the information provided within a given view 200a-c may correspond to information that is entirely provided by the MDM system 100. In this case, the view 200a-c may be presented as a pop-up window or overlay that is displayed over or alongside of a different view that displays locally stored and/or source information. For example, the user may normally view information via a browser and a browser plug in for causing the pop-up window or overlay may be installed. The view may be presented to the user on demand or under different circumstances.

Each view 200a-c may display one or more buttons 215 that facilitate specifying an indication of accuracy for a given field. For example, plus and minus buttons 215 may be provided to allow a user to indicate whether the user believes the information being provided by the MDM system 100 is accurate. A plus button click may be taken to mean that the user believes the information is accurate, while a minus button click may be taken to mean that the user believes the information to be inaccurate. In some implementations, the view may be configured to allow the user to provide what the user believes to be the correct value for a given field.

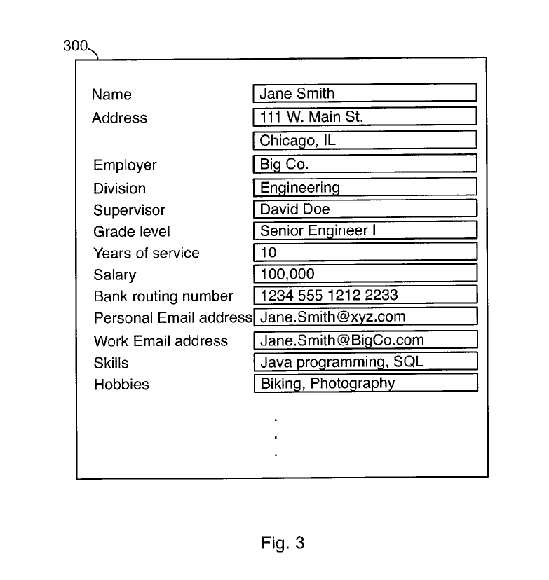

Returning to FIG. 1, information requested by the remote systems 140a-c may be retrieved from the master data 110. FIG. 3 illustrates an exemplary record 300 associated with a single entity, in this case an individual, which may be stored in the master data 110. The record 300 includes information for various fields or attributes associated with the individual, such as the individual's name, address, employer, etc. Information in the record 200 may have been sourced from one or more different sources, such as from structured and unstructured data 120a-b, and/or one or more of the remote systems 140a-c. For example, the individual's name, address, and employer information may have been sourced from the human resources system 140a. Bank routing information may have been sourced from the payroll system 140b. Skills and hobby information may have been sourced from the social networking system 140c.

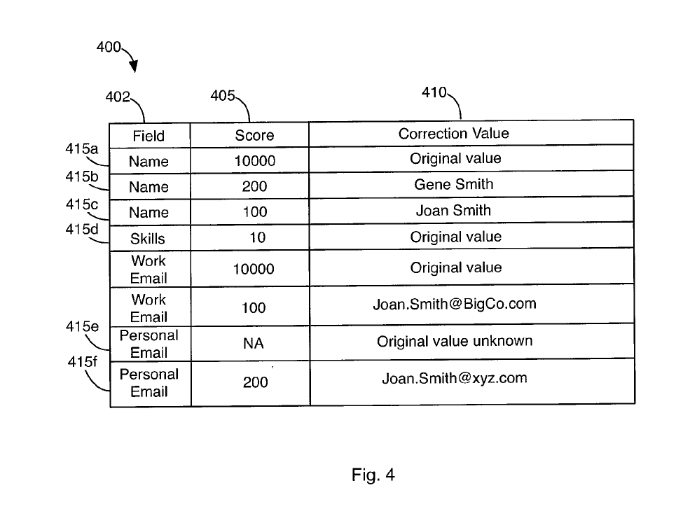

FIG. 4 illustrates an exemplary table 400 that represents a portion of validation data 115 that may be utilized by the processor 105 to validate information in the master data 110. The table 400 may include a field column 402, a score column 405, and a correction value column 410. Other fields may be provided. The field column 402 may include the names of fields within the master data 110. For example, the fields “name,” “skills,” “work email,” and “personal email” may be listed in the field column. The score column 405 provides a score that represents the determined accuracy of the original value, if any, associated with a corresponding field. The manner in which the score is determined is described later. Generally, however, the score is related to indications of validity provided by the remote systems 140a-c, such as the number of plus and minus button 215 clicks that were generated by a given remote system 140a-c for a particular field. The score provides a relative assessment as to the accuracy of the original information associated with a field and any possible replacement values for the field. For example, a score of 10000 for the original information associated with a field may indicate that the original information is very likely to be accurate as compared to a possible correction value with a score of 200. The correction values in the correction value column 410 correspond to either the original information associated with the field or a replacement value associated with the field.

In the exemplary table 400, the first three rows 415a-c include validation data associated with the field “name.” In the first row 415a, the score for the original information associated with the field “name,” in this case “Jane Smith,” is determined to be 10000. The second and third rows 415bc indicate possible correction values for the field “name” and their associated score. For example, the second row 415b indicates a score of 200 for the replacement value “Gene Smith,” and the third row 415c indicates a score of 100 for the replacement value “Joan Smith.” Given this information, the processor 105 may determine the original value of the field “name” as most likely correct.

The fourth row 415d indicates a score of 10 for the original value for the field “skills,” but no replacement value is provided in the table. The seventh row 415e indicates that no original value is known for the field “personal email.” However, the eighth row 415f indicates a score of 200 for a possible replacement value for the field “personal email.” As described in more detail below, the MDM system 100 may request additional feedback and or values for these fields from the remote systems 140a-c when information in the master data 110 is lacking. For example, the MDM system 100 may request information associated with the field “personal email” from remote systems 140a-c that may store this information.

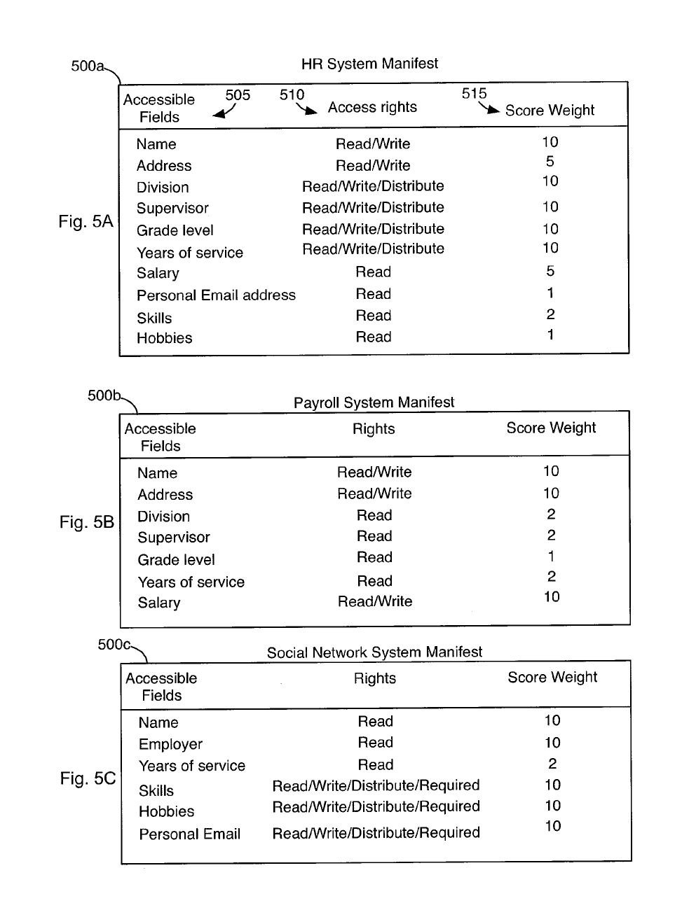

FIGS. 5A-C illustrate exemplary manifests 500a-c that may be associated with different remote systems 140a-c, such as the human resources system 140a, the payroll system 140b, and the social networking system 140c. Generally, the manifest 500a-c for a given remote system 140a-c define a set of fields 505 within the master data 110 to which the remote system 140a-c may have access. The manifest 500a-c may also specify access rights 510 for each field that define rules the remote system 140a-c may be required to follow when reading, writing/modifying, and distributing information stored in those fields. The manifest may be thought of as representing a trust association between the MDM system 100 and the remote systems 140a-c, or one or more users of the remote systems 140a-c. For example, a given remote system 140a-c may have read access to the information in certain fields, which permits the remote system 140a-c to retrieve the information from the master data 110. When write access is provided, the remote system 140a-c may be permitted to write and/or modify information associated with a corresponding field in the master data 110. When distribution access is provided, the remote system 140a-c may be permitted to distribute information associated with a corresponding field in the master data 110 to other systems.

For example, the manifest of FIG. 5A indicates that the human resources system 140a has read/write access to the fields “name,” “address,” and “division.” This indicates that a user of that system may read, write, and modify those fields. This type of access may be provided to the human resources system 140a because the system may be understood to be the most authoritative source for the provided information. With respect to the fields “division,” “supervisor,” “grade level,” and “years of service,” the human resources system 140a may also have distribution access, meaning that the remote system 140a-c may distribute information associated with these fields to other systems. With respect to the fields “salary,” “personal email address,” “skills,” and “hobbies,” the human resources system 140a may be limited to read access. Therefore, the user of the 140a may be able view the information, but may not be able to modify or distribute the information.

On the other hand, the manifest of FIG. 5B indicates that the payroll system 140b has read and write access to the field “salary” stored in the master data 110 because the payroll system 140b may be considered as the authoritative source for this information. The manifest of FIG. 5C indicates, among other things, that the social network system 140c has read/write/distribution access to the fields “skills,” “hobbies,” and “personal email” because the social network system 140c may be considered as the authoritative source for this information.

In some instances, the access rights may indicate that a given type of information is required from the remote system 140a-c to allow the remote system 140a-c to access other information. For example, the manifest of FIG. 5C indicates that information associated with the fields “skills,” “hobbies,” and “personal email” is required from the social network system in return for being given access to the information associated with the fields “name,” “employer,” and “years of service.” Such additional information may be beneficial, for example, to a human resources system 140a as the information may allow HR personnel to match an employee possessing these skills to a position within the enterprise that requires an individual with the same skills. On the other hand, the information provided by the MDM system 100 to the social network system 140c may be beneficial to the operator of the social network system 140c in that it may allow the operator to better monetize the information presented by the social network system 140c.

In some implementations, the remote system 140a-c may have previously provided the types of information gathered by the remote system 140a-c to the MDM system, such as during a registration process. This information may be utilized by the MDM system 100 in making requests for information from the remote systems 140a-c or in determining whether a given remote system 140a-c is capable of providing enough information to justify sharing other information in the master data 110 with the remote system 140a-c.

Each manifest 500a-c may also define a score weight 515 associated with a given field. The score weight 515 may be taken into consideration by the processor 105 in determining a relevance of any indications of validity generated by a remote system 140a-c in relation to a given piece of information stored in the master data 110. In general, the more authoritative a remote system 140a-c is with respect to a given piece of information, the higher the weight. For example, the weight associated with the field “salary” in the manifest 400b for the payroll system 140b may be set to ten, while the weight associated with the field “salary” in the manifest 500a for the human resources system 140a may be set to five. This may be taken to mean that indications of validity generated by the payroll system 140b are two times more relevant than indications of validity generated by the human resources system 140a.

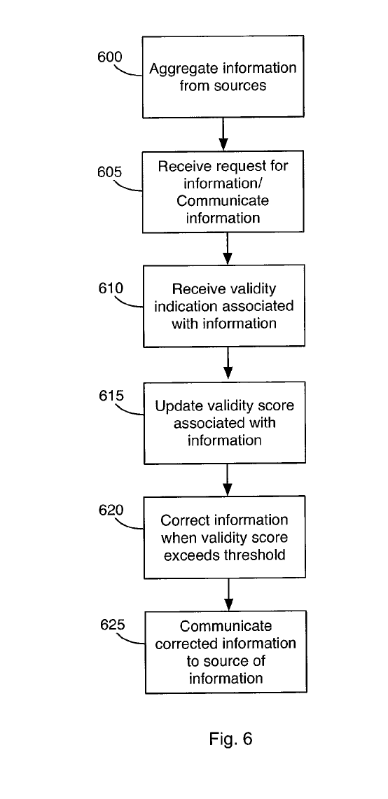

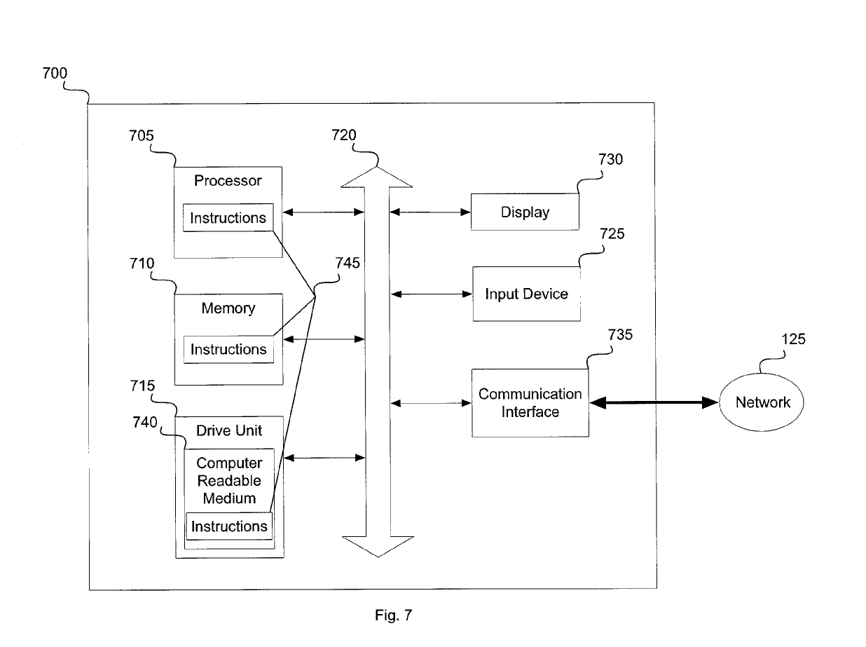

Operations of the MDM system 100 are described with reference to the block diagrams illustrated on FIG. 6. Some or all of the operations may be implemented via instruction code that resides on non-transitory computer-readable storage media of a computer system. Execution of the instruction code by the computer system may cause the computer system to perform the operations described in the block diagrams.

At block 600, information may be aggregated from a variety of sources. For example, the MDM system 100 may aggregate data from one or more structured data sources 130a, unstructured data sources 130b, and remote systems 140a-c into a database that stores master data 110. Data from these data sources may be communicated to the MDM system via a network 125, such as the Internet or a different network.

At block 605, the MDM system 100 may receive a request for information. For example, a user of a remote system 140a-c may activate an overlay view 200a-c, which in turn causes the remote system 140a-c to communicate a request to the MDM system 100 for information. The view 200a-c may be configured to present the requested information to the user. The user may activate the view 200a-c to obtain information from the master data 110 for the purpose of supplementing the locally available or sourced information, to verify the information, or for a different purpose.

Upon receiving the request, the processor 105 of the MDM system 100 may analyze a manifest 500a-c associated with the requesting remote system 140a-c to determine information from the master data 110 that may be communicated to the remote system 140a-c. The information determined to be accessible to the remote system 140a-c may then be communicated to the remote system 140a-c. In some implementations, the MDM system 100 may communicate access rights information to the remote system 140a-c. The remote system 140a-c may utilize this information to control the view 200a-c in which the information associated with the requested information may be displayed. For example, if the access rights specify read-only rights for a given field, then the information associated with that field may be displayed in an editor box that prevents editing.

In implementations where the access rights 510 indicate that information associated with one or more fields are required by the MDM system 100, the processor 105 may determine whether the remote system 140a-c has ever provided such information for any entities stored in the master data 110, or whether a quantity of times such information has been provided exceeds a pre-determined threshold. When the processor 105 determines that the remote system 140a-c has not provided such information, the MDM system 100 may refuse the request for information from the remote system 140a-c. In this manner, the MDM system 100 encourages the remote system 140a-c to provide the required information.

At block 610, the MDM system 100 may receive a validity indication from the remote system 140a-c. For example, a user of the remote system 140a-c may press a plus or minus button 215 associated with a given field to indicate the validity of the information specified in the field. In some implementations, the remote system 140a-c may be configured to prevent the user from repeatedly indicating the validity of the information. For example, after the user presses the plus button for a given field, the plus and minus button 215 for that field may be disabled to prevent further clicking by the user. In yet other implementations, the remote system 140a-c may cache the validity information for a time before sending the validity indications to the MDM system 100. This may occur, for example, when network access to the MDM system 100 is unavailable.

In other implementations, the validity indication may be determined based upon a different user action or action of the remote system 140a-c. For example, a phone number in the master data may be requested by a phone application on a remote system 140a-c. The phone application may attempt to place a call to the phone number. If the call succeeds, the application may communicate an indication to the MDM system 100 that the phone number is valid. Conversely, if the call fails, the application may communicate an indication that the phone number is invalid.

An email application may similarly request an email address for an individual from the master data to communicate email message. If the email message reaches the intended recipient, the email system may communicate an indication of validity to the MDM system. If the email message is returned as undeliverable, or if the email reaches a different individual, the email application may communicate an indication that the email address is invalid.

In yet other implementations, a search engine on a remote system 140a-c may consume information in the master data and provide indications of validity or invalidity to the MDM system based on user click's of search results provided by the search engine. For example, a searcher may submit a search query to the search engine for particular information, such as the address of an individual. The search engine may return results that match the query, which may have been provided by the master system. When the user clicks on a particular result/address, the search engine may be consider the selected address to be the valid address and may communicate an indication of validity to the MDM system associated with the selected address.

At block 615, the processor 105 of the MDM system 100 may update the current validity score 405 associated with the field 402 that is stored in the validation data 115 based on the validity indication communicated from the remote system 140a-c. For example, the MDM system 100 may receive five positive indications of validity from a remote system 140a-c, which may have been generated in response to five different users of the remote system 140a-c pressing the plus button 215 for a given field. The processor 105 of the MDM system 100 may then query the manifest 500a-c associated with the remote system 140a-c to determine a score weight 515 for the particular field. The processor 105 may then multiply the score weight 515 specified in the manifest 500a-c with the number of positive indications of validity to determine a validity score. For example, if the score weight 415 for a given field is ten, the validity score may be determined to be fifty. The processor 105 may then determine a weighted average of the current validity score stored in the validation data 115 and the new validity score. Other functions for updating the current validity score stored in the validation database 115 based on the new validity score may be employed.

In some implementations, the user of the remote system 140a-c may submit a new value for a field. Submission of the new value may be taken to mean that the current information associated with a given field in the validation data 115 is incorrect, in which case the validity score associated with the current value may be lowered. The amount by which the current value may be lowered may be based on the score weight 515 associated with the field that is specified in the manifest 500a-c associated with the remote system 140a-c. In addition, the new value provided by the user may be added to the validation data 115 as a possible alternative value for the field and provided with a score that is based on the score weight 515 specified in the manifest 500a-c. Each time a new user specifies the alternative value as the correct value, the score for the alternative value may increase, while the score associated with the current value may decrease.

In yet other implementations, information associated with certain fields may be related to a user of the remote system 140a-c. This fact may be communicated to the MDM system 100. For example, user credentials may be communicated to the MDM system 100 to authenticate the user. In this situation, the processor 105 may apply a much higher score weight to any fields that receive a validity indication that are directly related to the user of the remote system 140a-c. This, in turn, may lead to a greater likelihood that the information in the master data 110 will be taken as correct, or that alternative information specified by the user will be taken as correct.

At block 620, the processor 105 may correct information stored in the master data 110 based on the validity score for a given field. For example, when the validity score for a given alternative field value exceeds a threshold or is greater than other alternative values by a pre-determine amount, the processor 105 may replace the information associated with the field with the alternative values.

At block 625, the MDM system 100 may communicate the corrected information to the source of the information. For example, the MDM system 100 may communicate the corrected value for a field to a source database from which the original value was sourced.

FIG. 8 illustrates a computer system 700 that may form part of or implement the processor 105 of the MDM system 100, the remote systems 140a-c, or any other module referenced herein. The computer system 700 may include a set of instructions 745 that the processor 705 may execute to cause the computer system 700 to perform any of the operations described above. The computer system 700 may operate as a stand-alone device or may be connected, e.g., using a network, to other computer systems or peripheral devices.

In a networked deployment, the computer system 700 may operate in the capacity of a server or as a client-user computer in a server-client user network environment, or as a peer computer system in a peer-to-peer (or distributed) network environment. The computer system 700 may also be implemented as or incorporated into various devices, such as a personal computer or a mobile device, capable of executing the instructions 745 (sequential or otherwise) that specify actions to be taken by that machine. Further, each of the systems described may include any collection of sub-systems that individually or jointly execute a set, or multiple sets, of instructions to perform one or more computer functions.

The computer system 700 may include one or more memory devices 710 on a bus 720 for communicating information. In addition, code operable to cause the computer system to perform any of the operations described above may be stored in the memory 710. The memory 710 may be a random-access memory, read-only memory, programmable memory, hard disk drive or any other type of memory or storage device.

The computer system 700 may include a display 730, such as a liquid crystal display (LCD), a cathode ray tube (CRT), or any other display suitable for conveying information. The display 730 may act as an interface for the user to see the functioning of the processor 705, or specifically as an interface with the software stored in the memory 710 or in the drive unit 715.

Additionally, the computer system 700 may include an input device 725, such as a keyboard or mouse, configured to allow a user to interact with any of the components of system 700.

The computer system 700 may also include a disk or optical drive unit 715. The object database 125, printer database 130, and any other forms of storage referenced herein may be stored on the disk drive unit 715. The disk drive unit 715 may include a computer-readable medium 740 in which the instructions 745 may be stored. The instructions 745 may reside completely, or at least partially, within the memory 710 and/or within the processor 705 during execution by the computer system 700. The memory 710 and the processor 705 also may include computer-readable media as discussed above.

The computer system 700 may include a communication interface 735 to support communications via a network 750. The network 750 may include wired networks, wireless networks, or combinations thereof. The communication interface 735 network may enable communications via any number of communication standards, such as 802.11, 802.12, 802.20, WiMax, cellular telephone standards, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

While methods and systems have been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present methods and systems not be limited to the particular embodiment disclosed, but that the disclosed methods and systems include all embodiments falling within the scope of the appended claims.

We claim:

1. A method for maintaining the validity of data, the method comprising:
receiving, by a master data management (MDM) system and from a requesting system, a request to view information stored in master data of the MDM system;
communicating, by the MDM system, the information to the requesting system;
receiving, from the requesting system, data that defines a score that represents a validity of the information;
updating, by the MDM system, a validity score associated with the information; and
when the validity score indicates to the MDM system that the information is invalid, correcting the information.

2. The method according to claim 1, further comprising determining, by the MDM system, manifest information associated with the requesting system, wherein the manifest information defines a weight associated with the score received from the requesting system.

3. The method according to claim 1, wherein the manifest information defines a weight associated with a user associated with the request for the information.

4. The method according to claim 2, wherein the manifest information defines information that may be requested by the requesting system.

5. The method according to claim 2, wherein the manifest information defines access and distribution rights associated with information requested by the requesting system.

6. The method according to claim 2, wherein the manifest information defines information required from the requesting system, by the MDM system, to supplement information in the master data.

7. The method according to claim 6, wherein when the requesting system does not provide the required information specified in the manifest, the MDM system does not communicate the information to the requesting system.

8. The method according to claim 1, further comprising:
receiving, from the requesting system, corrected information;
generating, by the MDM system, a record that associates the information, the corrected information, and the validity score; and
when the validity score indicates to the MDM system that the information is invalid, replacing the information in the master data with the corrected the information.

9. The method according to claim 1, further comprising:
aggregating, by the MDM system, information from a plurality of sources into the master data, wherein the information originates from one of the plurality of sources; and
communicating the corrected information to the one of the plurality of sources from which the information was originated.

10. A master data management (MDM) system for maintaining the validity of data, the MDM system comprising:
a network interface configured to receive and process a request to view information stored in master data of the MDM system from a requesting system, to communicate the information to the requesting system, and to receive data that defines a score that represents a validity of the information from the requesting system; and
a processor configured to update a validity score associated with the information, wherein when the processor determines that the validity score indicates that the information is invalid, the processor is further configured to correct the information.

11. The system according to claim 10, wherein the processor is further configured to determine manifest information associated with the requesting system, wherein the manifest information defines a weight associated with the score received from the requesting system.

12. The system according to claim 10, wherein the manifest information defines a weight associated with a user associated with the request for the information.

13. The system according to claim 11, wherein the manifest information defines information that may be requested by the requesting system.

14. The system according to claim 11, wherein the manifest information defines access and distribution rights associated with information requested by the requesting system.

15. The system according to claim 11, wherein the manifest information defines information required from the requesting system, by the MDM system, to supplement information in the master data.

16. The system according to claim 15, wherein when the requesting system does not provide the required information specified in the manifest, the MDM system does not communicate the information to the requesting system.

17. The system according to claim 10, wherein the network interface is further configured to receive corrected information from the requesting system; and wherein the processor is further configured to generate a record that associates the information, the corrected information, and the validity score, and when the validity score indicates to the processor that the information is invalid, replace the information in the master data with the corrected the information.

18. The system according to claim 10, wherein the processor is further configured to aggregate information from a plurality of sources into the master data, wherein the information originates from one of the plurality of sources, and the processor is configured to cause the network interface to communicate the corrected information to the one of the plurality of sources from which the information was originated.

19. A non-transitory machine-readable storage medium having stored thereon a computer program comprising at least one code section for maintaining the validity of data, the at least one code section being executable by a machine for causing the machine to perform acts of:
receiving, from a requesting system, a request to view information stored in master data of the MDM system;
communicating the information to the requesting system;
receiving, from the requesting system, data that defines a score that represents a validity of the information;
updating a validity score associated with the information; and
when the validity score indicates to the MDM system that the information is invalid, correcting the information.

20. The non-transitory machine-readable storage medium according to claim 19, wherein the at least one code section is executable by the machine for causing the machine to determine manifest information associated with the requesting system, wherein the manifest information defines a weight associated with the score received from the requesting system.

21. The non-transitory machine-readable storage medium according to claim 20, wherein the manifest information defines a weight associated with a user associated with the request for the information.

22. The non-transitory machine-readable storage medium according to claim 20, wherein the manifest information defines information that may be requested by the requesting system.

23. The non-transitory machine-readable storage medium according to claim 20, wherein the manifest information defines access and distribution rights associated with information requested by the requesting system.

24. The non-transitory machine-readable storage medium according to claim 20, wherein the manifest information defines information required from the requesting system, by the MDM system, to supplement information in the master data.

25. The non-transitory machine-readable storage medium according to claim 24, wherein when the requesting system does not provide the required information specified in the manifest, the at least one code section is executable by the machine for causing the machine to prevent communication of the information to the requesting system.

26. The non-transitory machine-readable storage medium according to claim 19, wherein the at least one code section is executable by the machine for causing the machine to perform acts of:
receiving, from the requesting system, corrected information;
generating a record that associates the information, the corrected information, and the validity score; and
when the validity score indicates to the MDM system that the information is invalid, replacing the information in the master data with the corrected the information.

27. The non-transitory machine-readable storage medium according to claim 19, wherein the at least one code section is executable by the machine for causing the machine to perform acts of:
aggregating information from a plurality of sources into the master data, wherein the information originates from one of the plurality of sources; and
communicating the corrected information to the one of the plurality of sources from which the information was originated.
